(19) United States
(12) Patent Application Publication
(10) Pub. No.: US 2017/0053279 A1
(43) Pub. Date: Feb. 23, 2017

(54) Method for Authorization of Bank Card Purchases in Real Time Via Remote Devices

(71) Applicant: Samuel Richard Trapani, Rochester, NY (US)

(72) Inventor: Samuel Richard Trapani, Rochester, NY (US)

(21) Appl. No.: 14/622,857

(22) Filed: Feb. 14, 2015

Related U.S. Application Data
(60) Provisional application No. 61/940,400, filed on Feb. 15, 2014.

(51) Int. Cl. G06Q 20/40

(52) U.S. Cl. CPC G06Q 20/4012; G06Q 20/409

(57) ABSTRACT

A method for transaction approval may include requiring transaction approval, submitting personally identifiable information, and contacting a cardholder's remote electronic device at an address known only to a bank card issuer.

This application claims the benefit of U.S. Provisional Application No. 61940400 filed 2014 Feb. 15.

### BACKGROUND OF THE INVENTION

The problem of bank card fraud and abuse is running rampant in the world today. For the purpose of this application bank cards consist of both credit and debit cards but may include new types of cards that are not presently known but that function the same way as credit and debit cards.

Presently, when a purchase is attempted using a bank card for payment it is either approved or declined by the bank or its processor. For the purpose of this application the term bank or processor is interchangeable. This purchase process is accomplished either in-person or not-in-person. In any case there may exists fraud when certain conditions exist including but not limited to: a) the purchaser is not authorized to make the purchase on behalf of the legal card holder; or b) the card holder actually authorizes someone else to make the purchase and then claims that the purchase wasn't authorized; or c) the card holder actually makes the purchase and then claims that he/she didn't.

If the purchase was approved by the processor and it was a fraudulent purchase the card holder may not become aware of that situation for several days or weeks, if ever. By then it may be too late to stop the transaction and in the US the credit card company would be out the amount of the transaction because of federal law and the card holder may have a difficult time trying to recover charges made against their account.

The results of bank card fraud amounts to billions of dollars annually in the US alone.

The method claimed herein is unique and novel in that it provides a way for bank card issuers to greatly reduce such fraud thereby reducing associated losses.

### SUMMARY OF THE INVENTION

Bank card purchases are accomplished either in-person or not-in-person.

In the case of an in-person purchase the card holder may swipe their card on a terminal, or they may hand their card to the merchant, or server in a restaurant for example, to be swiped on a reader terminal or for the sales clerk to call into a bank card processing center to obtain authorization. Whenever the card is handed to someone the risk for fraud increases because the person receiving the card may have an opportunity to capture the card number, expiration date, and security code printed on the card and use it at a subsequent time and place. In the case of a debit card, the card holder is sometimes required to enter their personal identification number (PIN) on a private terminal so no one can see the entry.

This greatly reduces the possibility of fraud. In the case of a credit card the PIN entry is usually not required however some gasoline stations are now requiring the card holder to enter either their PIN or zip code to help reduce fraud. This practice should be mandatory for all in-person bank card transactions so as to reduce fraud.

In the case of not-in-person transactions the only information usually required by the merchant is the card number, expiration date, and security code. As mentioned previously, this information is very easily captured during in-person sales transactions. A purchase of this type can be done on-line with no dialogue with an attendant or it may be by a telephone conversation with an attendant. In either case this method is highly susceptible to fraud.

The subject of this patent application disclosure is a method to reduce or eliminate fraud primarily from not-in-person bank card purchases, although the method disclosed herein is applicable to in-person bank card purchases as well.

The method disclosed herein is a novel and unique way for the card processor to include the card holder in the authorization process. In this method the card holder would be required to enter information known only to him/her, and the processor or bank, after the merchant submits the transaction information to the processor but prior to an authorization being granted. If the correct information is entered by the card holder then the transaction could be approved. If incorrect information was entered then the transaction would be denied.

This method does not exist today and would substantially reduce bank card fraud for both in-person and not-in-person purchases.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 depicts a method for authorizing bank card transactions in accordance with embodiments.

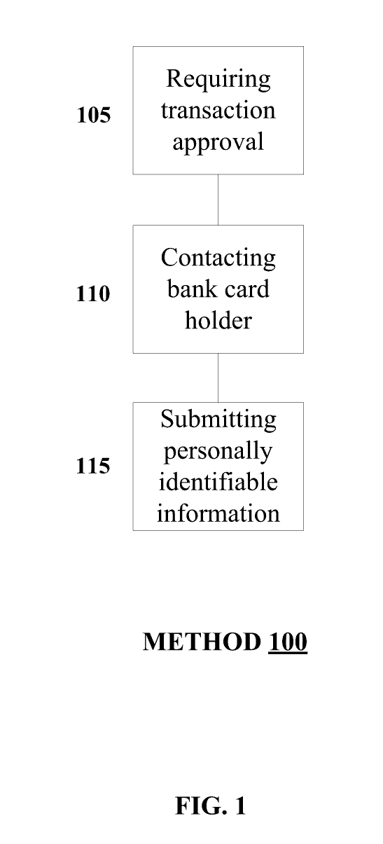

FIG. 2 depicts a system for authorizing bank card transactions in accordance with embodiments.

### DETAILED DESCRIPTION OF THE INVENTION

Whenever a not-in-person bank card purchase is attempted the card holder 220 usually performs the purchase either on-line with no dialogue with the merchant 205 or it may be by a telephone conversation with the merchant 205. In either case information given to the merchant 205 usually includes card number, expiration date, and security code. Some merchants 205 also collect billing address or other information that further increases the vulnerability of the card holder's account. This information is all that is typically needed to successfully complete a not-in-person transaction. Once this information is given to the merchant 205 it may be kept by the merchant 205 and then be subject to compromise at some later time. Even worse would be the case where the merchant 205 keeps the information and uses it fraudulently at a later time.

The method described herein could only require the card holder 220 to provide the card number and no other information. That reduction in information greatly reduces the possibility of fraud by a third party.

As mentioned previously, if the purchase was approved and it was a fraudulent purchase the card holder 220 may not become aware of that situation for several days or weeks. By then it may be too late to stop the transaction and the credit card company would be out the amount of the transaction because of federal law in the United States.

By placing the card holder 220 in the authorization process loop, and requiring the card holder 220 to enter a PIN number remotely, or some other identifying code, the processor 210 definitively verifies that the purchase was actually approved by the card holder 220 and it would be very difficult for the card holder 220 to claim fraud.

The following set of steps describe the method 100 claimed herein however there may be other steps that employ remote verification by the card holder in the case of a not-in-person transaction that are not precluded:
1. The card holder 220 contacts the merchant's online site or telephone attendant and places an order.
2. The merchant 205 totals the order and collects only the bank card number.
3. The merchant 205 then transmits the transaction information to the processor 210.
4. The processor 210 sends 110 the transaction information to the card holder 220 via telephone, text message, e-mail, instant messaging, or a combination of any or all of these methods and any other such means, for approval. The transmission would be sent 110 to the card holder 220 using contact information only known to the card processor 210 and using secured encrypted technology if available.
5. Once the card holder 220 receives the request they may reply by either approving or disapproving the transaction. The request could come with some sort of photo or other easily recognized preselected symbol or word so the card holder 220 knows it is from their bank 225 or processor 210. In either case in their reply the card holder 220 must also provide their PIN number or some other code, etc., known only to the processor 210 and card holder 220 so the processor 210 knows the card holder 220 responded to the request. If the request is not approved by the card holder 220 or if the correct information, PIN, etc., is not provided then the transaction will be treated as not approved by the card holder 220 and the attempt may be classified as fraudulent with both the merchant 205 and card holder 220 being notified. The bank 225 could also take further action on the particular merchant 205 or card holder 220 based upon a number of factors including frequency of attempts for a particular card holder 220, frequency of similar transaction attempts by a particular merchant 205, etc.
6. If and when the processor receives the reply it will either be approved or denied by the card holder 220 based upon the above process. If no reply is received within a predetermined period of time (8 hours for example, but could be any length of time predetermined by the processor) then the transaction will not be approved and the attempt may be classified as fraudulent with both the merchant 205 and card holder 220 being notified and further action may be taken as described above.
7. At some point in this process the processor 225 will determine if the card holder's account has enough credit or cash balance to allow the transaction to be approved by the processor 210. The processor 210 would probably want to contact the card holder 220 even if the transaction was not approved because of lack of credit or cash balance so attempted fraud could be identified and proper action taken.
8. Once the transaction is either approved or declined by the processor 210 the determination would be sent to the card holder 220 and the merchant 205 for processing.

There are other ways the process for remote card holder authorization could flow and they are not precluded. The novel and unique method disclosed herein is the concept of remote authorization. A similar method may be employed for in-person transactions. Typically, this would be a real-time situation. The bank card 215 is swiped on a processor 210 connected terminal or the card information is manually called into the processing center for authorization. At that point the processor 210 would then contact the card holder 220 using the same method 100 as described in the steps enumerated above. This method is viable for the purpose of providing legal card holder verification of a transaction outside of the merchant's control, which is the novel and unique method disclosed herein. Typically this method would not be employed because the use of a PIN entry station may be used at the point of sale. However with fraud on the increase it is possible for the merchant 205 to capture the card holder's PIN number on their PIN entry station and then use that information fraudulently at a later time so there is an opportunity to reduce fraud from these situations by employing the method described.

An application, or “app” as it is commonly called, has been developed which functions to make the card holder's device function as a remote PIN entry terminal for their credit card that only the bank or processor 210 can connect to. This may speed up the approval process with an increased level of security.

In embodiments, a bank card transaction approval method exists requiring 105 the bank card holder 220 to approve or disapprove a transaction approval request by submitting 115 personally identifiable information such as a PIN code, known only to the bank card issuer or their agents and the cardholder 220, via one or more of the cardholder's remote electronic device, which includes but is not limited to smart phones, personal computers, or tablets, which said device is contacted 110 through a wireless or wired network by the bank card issuer 225 or their agents by any number of different techniques including but not limited to e-mail, texting, or instant messaging, at an address only known to the bank card issuer 225 previously provided by the cardholder 220.

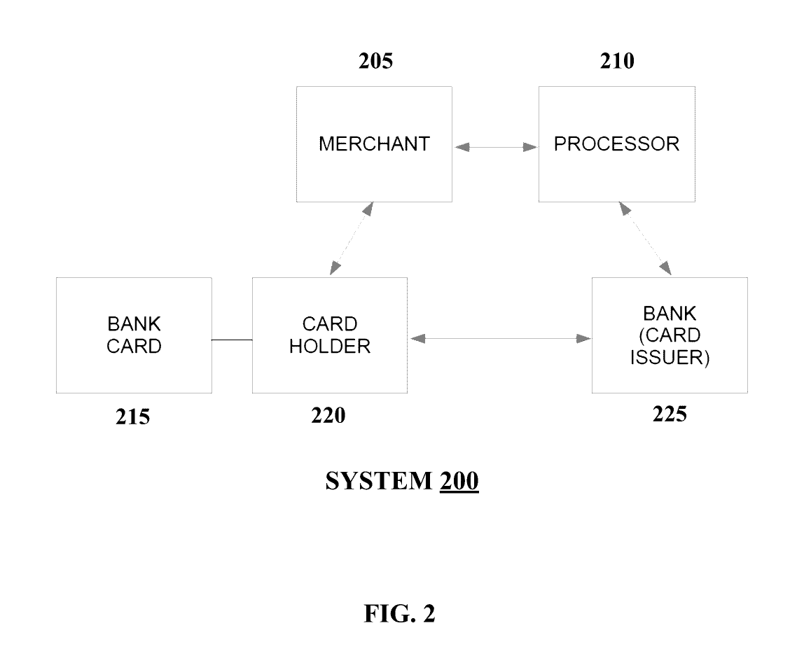

Methods herein disclosed may be performed by systems such as, for example, system 200 as shown in FIG. 2. In an embodiment, system 200 may include a merchant 205, a processor 210, a bank card 215, a card holder 220, and a bank (card issuer) 225.

1. A bank card transaction approval method requiring the bank card holder to approve or disapprove a transaction approval request by submitting personally identifiable information such as a PIN code, known only to the bank card issuer or their agents and the cardholder, via one or more of the cardholder's remote electronic device, which includes but is not limited to smart phones, personal computers, or tablets, which said device is contacted through a wireless or wired network by the bank card issuer or their agents by any number of different techniques including but not limited to e-mail, texting, or instant messaging, at an address only known to the bank card issuer previously provided by the cardholder.
